(19) United States
(12) Patent Application Publication
(10) Pub. No.: US 2019/0157650 A1
(43) Pub. Date: May 23, 2019

(54) NON-AQUEOUS ELECTROLYTE SECONDARY BATTERY

(71) Applicant: Panasonic Intellectual Property Management Co., Ltd., Osaka-shi (JP)

(72) Inventors: Yuji Oura, Osaka (JP); Takahiro Takahashi, Osaka (JP); Tomoki Shiozaki, Osaka (JP); Hajime Nishino, Nara (JP)

(73) Assignee: Panasonic Intellectual Property Management Co., Ltd., Osaka-shi (JP)

(21) Appl. No.: 16/253,494

(22) Filed: Jan. 22, 2019

Related U.S. Application Data
(63) Continuation of application No. PCT/JP2017/022308, filed on Jun. 16, 2017.

(30) Foreign Application Priority Data
Jul. 28, 2016 (JP) 2016-148354

(51) Int. Cl. H01M 2/26; H01M 2/34

(52) U.S. Cl. CPC H01M 2/26; H01M 2/34

(57) ABSTRACT

According to the present invention, a positive electrode of a lithium secondary battery is provided with an insulating tape that covers an electrode tab on an exposed part. This insulating tape has a multilayer structure that is composed of an organic material layer, a composite material layer which is formed from an organic material and an inorganic material, and an adhesive layer. The inorganic material in the composite material layer accounts for 20% or more of the weight of the composite material layer; and the inorganic material contains at least one substance selected from the group consisting of metal oxides, metal nitrides, metal fluorides and metal carbides. Puncture strength is ensured by means of the organic material layer, while heat resistance is ensured by means of the composite material layer.

### TECHNICAL FIELD

The present invention relates to a non-aqueous electrolyte secondary battery.

### BACKGROUND ART

Conventionally, lithium secondary batteries having the insulating property of a positive electrode or a negative electrode improved by using a protective tape have been proposed.

Patent Literature 1 describes a lithium secondary battery in which breakage of a current collector at a portion where a current collector and a lead are in contact with each other is suppressed.

FIGS. 6A and 6B are configuration diagrams of a positive electrode of the lithium secondary battery described in Patent Literature 1. FIG. 6A is a partial top plan view observed from one main surface side of the current collector, and FIG. 6B is a sectional view along the line VIB-VIB in FIG. 6A.

A protective layer 28 having a rectangular planar outline is formed on a positive electrode current collector exposed surface 21a in a both surfaces-uncoated portion 21b where a positive electrode mixture layer 21B is not formed. The protective layer 28 is formed substantially at the center of the both surfaces-uncoated portion 21b. Specifically, in order that a part of the protective layer 28 is interposed among the lower edge of a lead 25, a part of both side edges of the lead 25 and the positive electrode current collector exposed surface 21a, a part of the center of the protective layer 28 is interposed between the lower end portion of the lead 25 and the positive electrode current collector exposed surface 21a. Examples of the protective layer 28 include a resin layer, an inorganic material layer, and the like, and examples of the resin layer include a resin film, a resin tape, and the like. Examples of the resin film include a resin coating film coated with a resin such as PVDF (polyvinylidene fluoride) film and the like. Examples of the resin tape include a PP (polypropylene) tape, a PI (polyimide) tape, a PET (polyethylene terephthalate) tape, and the like, and examples of the inorganic material layer include an inorganic tape and the like. The protective tape 27 covers the positive electrode current collector exposed surface 21a, the lead 25, and the protective layer 28 on the one main surface side of the positive electrode current collector 21A and covers the positive electrode current collector exposed surface 21a on the other main surface side of the positive electrode current collector 21A. The protective tape 27 is, for example, a tape for preventing heat generation of the battery when the separator or the like is torn at the time of battery abnormality and the positive electrode 21 and the negative electrode 22 are in contact with each other, and the protective tape 27 is, for example, a resin tape or the like.

As a tape used in a different portion, Patent Literature 2 describes an insulating tape formed by a composite material tape, in which the composite material tape has an organic material forming an underlying layer and an inorganic material dispersed in the organic material, and the inorganic material has a content of 20 to 80% with respect to the total weight of the composite material tape.

### CITATION LIST

### Patent Literature

Patent Literature 1: Japanese Patent Laid-Open Publication No. 2014-89856

Patent Literature 2: Japanese Patent Laid-Open Publication No. 2010-192462

### SUMMARY

In Patent Literature 1, only an abnormal mode due to foil breakage is assumed and a short circuit via foreign matter (having conductivity) cannot be prevented. Particularly, in the case that foreign matter is mixed in the vicinity of the joint portion between the exposed portion of the current collector and the electrode tab (lead) or in the vicinity of the boundary portion between the exposed portion and the active material layer (mixture layer), both heat resistance and piercing strength of the tape covering them are required for preventing a short circuit. The heat resistance described here refers to a characteristic of suppressing deformation and deterioration of the tape due to heat, allowing to suppress the heat generation of the battery due to the continuation of the short circuit. Securing the heat resistance of the base material of the tape requires increasing the content of the inorganic material. However, increasing the content of the inorganic material lowers the piercing strength. On the contrary, ensuring the piercing strength of the base material of the tape requires lowering the content of the inorganic material. However, the heat resistance is lowered.

The present disclosure has been made in view of the above-described problems of the prior art, and the object thereof is to provide a non-aqueous electrolyte secondary battery having heat resistance and piercing strength (mechanical strength) at the same time.

The non-aqueous electrolyte secondary battery according to one embodiment of the present disclosure has a positive electrode and a negative electrode, and at least any one of the positive electrode and the negative electrode includes a current collector, an active material layer formed on the current collector, an electrode tab joined to an exposed portion where the active material layer is not formed and the current collector is exposed, and an insulating tape covering the electrode tab on the exposed portion. The insulating tape has a multilayer structure containing an organic material layer mainly composed of an organic material and a composite material layer containing an organic material and an inorganic material. The inorganic material in the composite material layer accounts for 20% or more of the weight of the composite material layer. The inorganic material includes at least one selected from the group consisting of a metal oxide, a metal nitride, a metal fluoride, and a metal carbide.

The non-aqueous electrolyte secondary battery according to another embodiment of the present disclosure has a positive electrode and a negative electrode, and at least any one of the positive electrode and the negative electrode includes a current collector, an active material layer formed on the current collector, and an insulating tape covering the boundary portion between an exposed portion where the active material layer is not formed and the current collector is exposed and the active material layer. The insulating tape has a multilayer structure containing an organic material layer mainly composed of an organic material and a composite material layer containing an organic material and an inorganic material. The inorganic material in the composite material layer accounts for 20% or more of the weight of the composite material layer. The inorganic material includes at least one selected from the group consisting of a metal oxide, a metal nitride, a metal fluoride, and a metal carbide.

According to the present disclosure, the multilayer structure of the organic material layer and the composite material layer can ensure both heat resistance and piercing strength (mechanical strength) of the insulating tape. Therefore, according to the present disclosure, a short circuit due to contamination of foreign matter can be suppressed, the heat resistance can be ensured even if a short circuit occurs, and an increase in battery temperature can be suppressed.

### BRIEF DESCRIPTION OF DRAWINGS

FIG. 1 is a partially sectional view of the insulating tape according to an embodiment.

FIG. 2 is a partially sectional view of the insulating tape according to another embodiment.

FIG. 3 is a partially sectional view of the insulating tape according to still another embodiment.

FIG. 4A is a schematic view showing an example of a configuration of an electrode used in the non-aqueous electrolyte secondary battery according to the present embodiment, and is a partial top view observed from one main surface side of the electrode.

FIG. 4B is a sectional view along the line IVB-IVB in FIG. 4A.

FIG. 5A is a schematic view showing another example of a configuration of an electrode used in the non-aqueous electrolyte secondary battery according to the present embodiment, and is a partial top view observed from one main surface side of the electrode.

FIG. 5B is a sectional view along the line VB-VB in FIG. 5A.

FIG. 6A is a configuration diagram of a positive electrode of a lithium secondary battery of the prior art, and is a partial top view observed from one main surface side of a current collector.

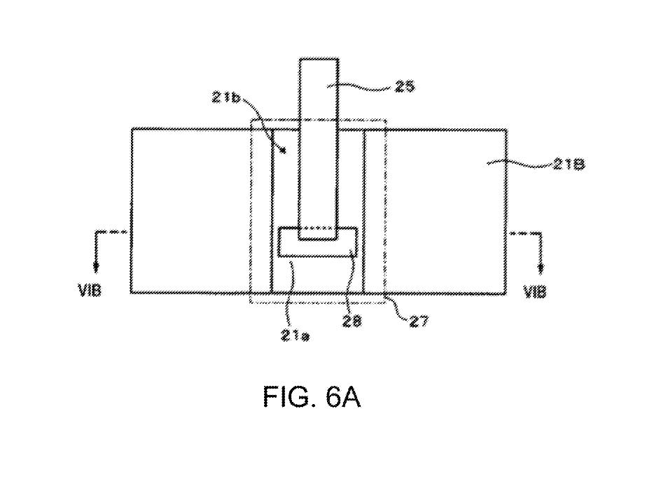

FIG. 6B is a sectional view along the line VIB-VIB in FIG. 6A.

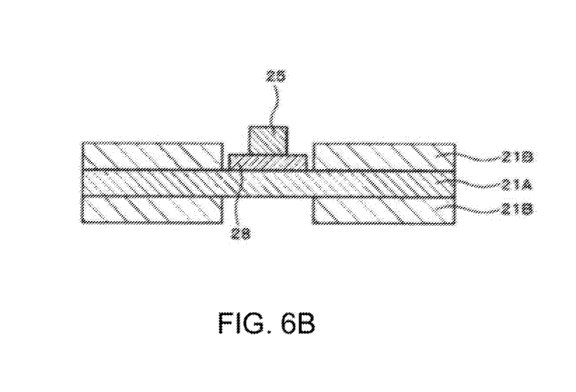

### DESCRIPTION OF EMBODIMENTS

Hereinafter, embodiments in the present disclosure will be described with reference to the drawings.

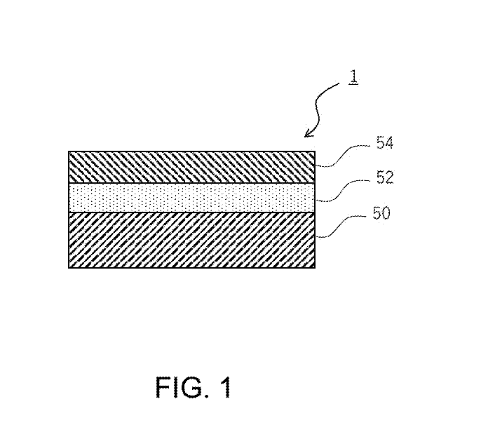

FIG. 1 is a partially sectional view of an insulating tape 1 according to the present embodiment. The insulating tape 1 is composed of an organic material layer 50, a composite material layer 52 composed of an organic material and an inorganic material, and an adhesive layer 54.

The organic material layer 50 is not particularly limited as long as it is a layer mainly composed of an organic material, but for example, PPS (polyphenylene sulfide), PEEK (polyether ether ketone), PI (polyimide), PP (polypropylene), PET (polyethylene terephthalate), PBT (polybutylene terephthalate), or the like may also be used. Particularly, PI with high piercing strength is preferably used. The thickness of the organic material layer 50 is arbitrary and may be, for example, 25 μm.

The organic material of the organic material layer accounts for 90% by weight or more of the weight of the organic material layer, and preferably does not contain an inorganic material.

The composite material layer 52 is formed by dispersing an inorganic material in a predetermined powder form in an underlying layer of an organic material. A content of the inorganic material is 20% or more with respect to the weight of the composite material layer 52. In the present specification, % means weight %. As the organic material, a rubber resin, an acrylic resin, an epoxy resin, a silicone resin, or the like can be used, but it is not particularly limited. In order to increase the affinity between the organic material and the adhesive layer 54, the organic material of the composite material layer 52 and the adhesive layer 54 are preferably composed of the same type of resin.

The inorganic material includes at least one selected from the group consisting of a metal oxide, a metal nitride, a metal fluoride, and a metal carbide. Examples of the metal oxide include aluminum oxide, titanium oxide, magnesium oxide, zirconium oxide, nickel oxide, silicon oxide, manganese oxide, and the like, and from the viewpoints of nonconductivity, high melting point and the like, aluminum oxide, titanium oxide, magnesium oxide, zirconium oxide, nickel oxide, and the like are preferable among these. Examples of the metal nitride include titanium nitride, boron nitride, aluminum nitride, magnesium nitride, silicon nitride and the like, and from the viewpoints of nonconductivity, high melting point and the like, titanium nitride, boron nitride, aluminum nitride, and the like are preferable among these. Examples of the metal fluoride include aluminum fluoride, lithium fluoride, sodium fluoride, magnesium fluoride, calcium fluoride, barium fluoride, and the like, and from the viewpoints of nonconductivity high melting point and the like, aluminum fluoride, lithium fluoride, sodium fluoride, magnesium fluoride, and the like are preferable among these. Examples of the metal carbide include silicon carbide, boron carbide, titanium carbide, tungsten carbide, and the like, and from the viewpoints of nonconductivity high melting point and the like, silicon carbide, boron carbide, titanium carbide, and the like are preferable among these.

The adhesive layer 54 is not particularly limited as long as it is formed of a material having adhesiveness to an attachment site (electrode tab or the like described later), and from the viewpoint of easy attachment work or the like, preferably a resin having adhesiveness at a room temperature and preferably composed of, for example, a rubber resin, an acrylic resin, a silicone resin, or the like. The insulating tape 1 may be composed of at least the organic material layer 50 and the composite material layer 52, and the adhesive layer 54 is not an essential component. When the insulating tape 1 without the adhesive layer 54 is used, for example, an adhesive may be applied to the attachment site and the insulating tape 1 may be pasted thereon.

As described above, ensuring the heat resistance of the base material of the tape requires increasing the content of the inorganic material. However, increasing the content of the inorganic material lowers the piercing strength. On the contrary, ensuring the piercing strength of the base material requires lowering the content of the inorganic material. However, the heat resistance is lowered.

In the present embodiment, instead of a two-layer structure of a composite material layer and an adhesive layer (substantially a single layer structure of a composite material layer) as in the prior art, as shown in FIG. 1, adopting a three-layer structure of the organic material layer 50/the composite material layer 52/the adhesive layer 54 (substantially, the two-layer structure of the organic material layer 50/the composite material layer 52) can achieve both heat resistance and piercing strength.

Setting the content of the inorganic material in the composite material layer 52 at 20% or more thus improves the heat resistance of the composite material layer 52. As a result, the piercing strength is lowered. However, the piercing strength is ensured with the organic material layer 50, resulting in ensuring both heat resistance and piercing strength of the entire insulating tape 1.

The content of the inorganic material in the composite material layer 52 is preferably 20% or more with respect to the weight of the composite material layer 52, more preferably 35 to 80%. When the content of the inorganic material is as low as less than 20%, the effect of improving the heat resistance is reduced. When the content of the inorganic material is as high as more than 80%, it is difficult to ensure the function as a tape.

The inorganic material may be uniformly dispersed in the composite material layer 52 or may be dispersed so as to have a concentration gradient. From the viewpoint of improving the strength of the insulating tape 1, as the dispersion form having a concentration gradient, the inorganic material is preferably dispersed such that the content of the inorganic material rises from the surface of the composite material layer 52 in contact with the organic material layer 50 to the surface of the composite material layer 52 in contact with the adhesive layer 54. Since the adhesive layer 54 is contact with the attachment site (electrode tab or the like), in other words, the inorganic material in the composite material layer 52 is preferably dispersed in the composite material layer 52 so that the content of the inorganic material rises with approaching the attachment site of the electrode tab or the like.

The upper limit of the weight of the inorganic material is preferably less than 20% with respect to the total weight of the layers excluding the adhesive layer 54 (the total weight of the organic material layer 50 and the composite material layer 52). The upper limit of the weight of the inorganic material is more preferably 10% or less. The lower limit of the weight of the inorganic material is preferably 5% or more. Thus, increasing the weight proportion (content) of the inorganic material in the composite material layer 52 and decreasing the weight proportion (content) of the inorganic material in the entire tape can improve both heat resistance and piercing strength.

The thickness of the composite material layer 52 is also arbitrary, and preferably 1 to 5 μm. When the thickness is as small as less than 1 μm, the effect of increasing the heat resistance of the composite material layer 52 decreases. When the thickness is as large as more than 5 μm, it is difficult to ensure the function as an insulating tape.

In the insulating tape 1 of the present embodiment, the occurrence of a short circuit itself can be suppressed because the mechanical strength (piercing strength) is ensured even when a short circuit due to foreign matter is assumed.

When a short circuit occurs due to foreign matter, the heat resistance is ensured by the composite material layer 52, allowing to prevent continuation of the short circuit.

In the present embodiment, as shown in FIG. 1, the insulating tape 1 is formed by laminating the organic material layer 50/the composite material layer 52/the adhesive layer 54 in this order, and the lamination order may be changed to be the composite material layer 52/organic material layer 50/adhesive layer 54.

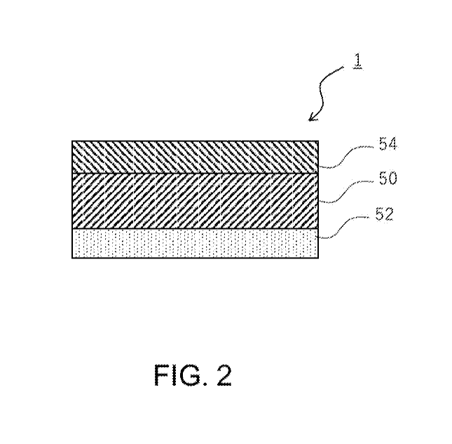

FIG. 2 shows a sectional view of the insulating tape 1 in this case. The insulating tape 1 is formed by laminating the composite material layer 52/the organic material layer 50/an adhesive layer 54 in this order. In short, it is desirable to form the insulating tape 1 including the organic material layer 50, the composite material layer 52, and the adhesive layer 54.

As described above, the inorganic material may be uniformly dispersed in the composite material layer 52 or may be dispersed so as to have a concentration gradient. From the viewpoint of improving the strength of the insulating tape 1, as the dispersion form having a concentration gradient, the inorganic material is preferably dispersed such that the content of the inorganic material rises from the opposite surface of the composite material layer 52 in contact with the organic material layer 50 to the surface of the composite material layer 52 in contact with the organic material layer 50. In other words, the inorganic material in the composite material layer 52 is preferably dispersed in the composite material layer 52 such that the content of the inorganic material rises as approaching the attachment site of the electrode tab or the like.

In the present embodiment, the insulating tape 1 is formed by including the organic material layer 50, the composite material layer 52, and the adhesive layer 54, and in addition to these layers, may include additional layers. For example, the composite material layer 52 itself may have a multilayer structure, and the weight ratio of the organic material and the inorganic material in each layer may be changed.

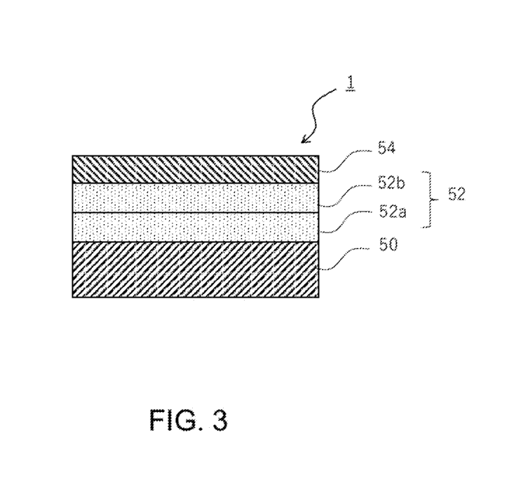

FIG. 3 shows a sectional view of the insulating tape 1 in this case. The organic material layer 50/the composite material layer 52/the adhesive layer 54 are laminated in this order as the same in FIG. 1, and the composite material layer 52 is composed of two layers of the composite material layer 52a and the composite material layer 52b. The composite material layer 52a and the composite material layer 52b may have the same or different weight composition ratios of the organic material and the inorganic material to each other. In both composite material layer 52a and composite material layer 52b, the inorganic material preferably accounts for 20% or more of the weight of the composite material layer. In FIG. 3, at least one of the organic material and the inorganic material in the composite material layer 52a and the composite material layer 52b may be different.

In the case that the weight composition ratio of the organic material and the inorganic material is different between the composite material layer 52a and the composite material layer 52b, from the viewpoint of improving the strength of the insulating tape 1, the content of the inorganic material in the composite material layer 52b in contact with the adhesive layer 54 is preferably higher than that of the inorganic material in the composite material layer 52a in contact with the organic material layer 50. In the case that the composite material layer 52 is a multilayer, each layer is preferably arranged such that the layer closer to the attachment site of the electrode tab or the like has a higher content of the inorganic material.

Hereinafter, examples where the insulating tape 1 of the present embodiment was applied to an electrode of a non-aqueous electrolyte secondary battery will be described. The electrode below represents at least any one of a positive electrode and a negative electrode of the non-aqueous electrolyte secondary battery.

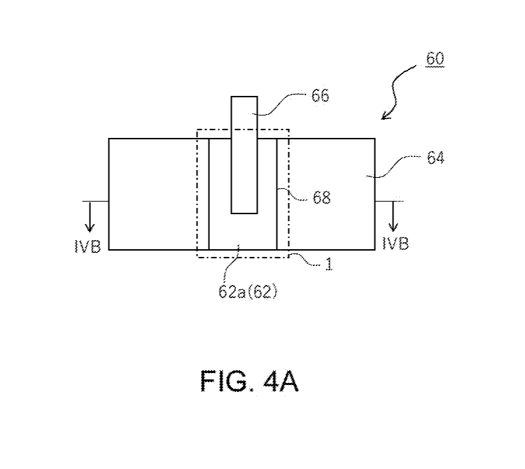

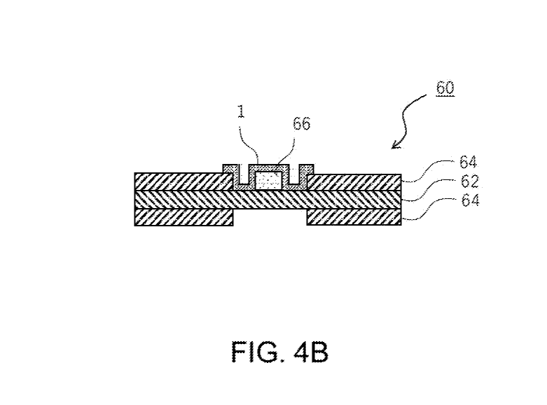

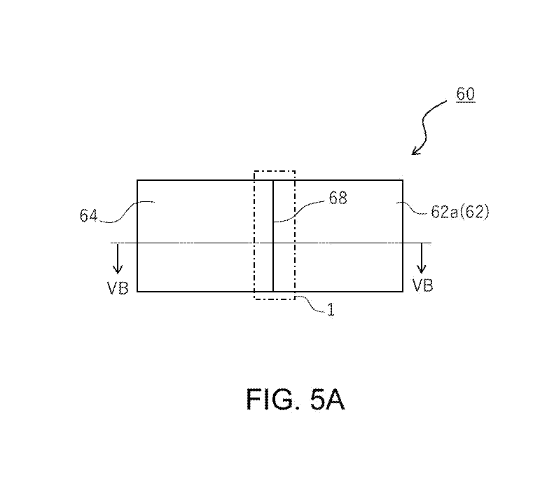

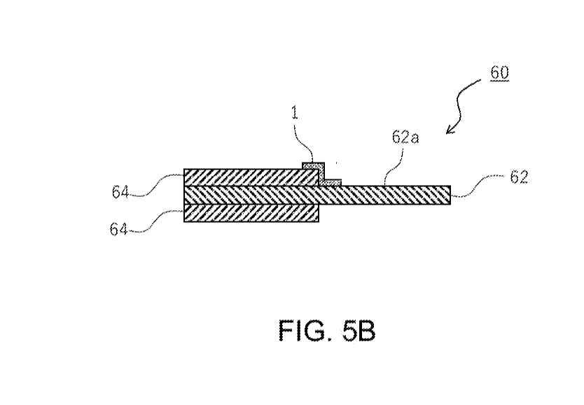

FIGS. 4A and 4B are schematic views showing an example of a configuration of an electrode used in the non-aqueous electrolyte secondary battery according to the present embodiment. FIG. 4A is a partial top view observed from one main surface side of the electrode, and FIG. 4B is a sectional view along the line IVB-IVB in FIG. 4A. In FIG. 4A, in order to clarify the configuration of the electrode, the insulating tape 1 is shown as a perspective diagram and is indicated by an alternate long and short dash line. The following FIGS. 5A and 5B are the same.

As shown in FIGS. 4A and 4B, an electrode 60 used for a non-aqueous electrolyte secondary battery comprises a current collector 62 and an active material layer 64 formed on the current collector 62. In the electrode 60 shown in FIGS. 4A and 4B, an exposed portion 62a where the active material layer 64 is not formed and the current collector 62 is exposed is formed. The exposed portion 62a is formed, for example, substantially at the center portion in the longitudinal direction of the band-like electrode. The electrode 60 shown in FIGS. 4A and 4B comprises an electrode tab 66, and the electrode tab 66 is joined to the exposed portion 62a on one main surface side of the electrode 60 by ultrasonic welding or the like.

The electrode 60 shown in FIGS. 4A and 4B are provided with the above-described insulating tape 1. The insulating tape 1 adheres to the electrode 60 so as to cover the electrode tab 66 on the exposed portion 62a on the one main surface side of the electrode 60 and the exposed portion 62a. The insulating tape 1 may cover the electrode tab 66 on the exposed portion 62a, and when there is the exposed portion 62a (margin) between the electrode tab 66 and the active material layer 64 or the like, as shown in FIGS. 4A and 4B, from the view point of further suppressing occurrence of a short circuit due to contamination of foreign matter, preferably a part of the exposed portion 62a is covered, and more preferably the entire surface of the exposed portion 62a is covered. In the electrode 60 shown in FIGS. 4A and 4B, the entire surface of the exposed portion 62a is covered with the insulating tape 1, thereby also covering the boundary portion 68 between the exposed portion 62a and the active material layer 64.

FIGS. 5A and 5B are schematic views showing another example of a configuration of an electrode used in the non-aqueous electrolyte secondary battery according to the present embodiment. FIG. 5A is a partial top view observed from one main surface side of the electrode, and FIG. 5B is a sectional view along the line VB-VB in FIG. 5A. In the electrode 60 shown in FIGS. 5A and 5B, for example, the exposed portion 62a is formed at the end portion in the longitudinal direction of the band-like electrode. The insulating tape 1 adheres to the electrode 60 so as to cover the boundary portion 68 between the exposed portion 62a and the active material layer 64.

For example, the non-aqueous electrolyte secondary battery according to the present embodiment can be obtained by accommodating the electrode body obtained by laminating or winding the electrode (positive electrode, negative electrode) to which the above insulating tape is applied and the separator in a container such as a battery can or a laminate together with the non-aqueous electrolyte. Known materials can be used for the positive electrode, the negative electrode, the separator, and the non-aqueous electrolyte in the present embodiment, and these examples are as follows.

### <Positive Electrode>

The positive electrode comprises a positive electrode current collector such as a metal foil and a positive electrode active material layer (hereinafter, sometimes referred to as a positive electrode mixture layer) formed on the positive electrode current collector. As the positive electrode current collector, a metal foil that is stable in the potential range of the positive electrode such as aluminum, a film in which the metal is disposed on the surface layer, and the like can be used. In addition to the positive electrode active material, the positive electrode mixture layer preferably contains a conductive material and a binder. The positive electrode is prepared by, for example, coating a positive electrode mixture slurry containing a positive electrode active material, a binder, and the like on a positive electrode current collector, drying the coating film, and then rolling the film to form the positive electrode mixture layer on both surfaces of the positive electrode current collector.

Examples of the positive electrode active material include lithium transition metal complex oxide and the like, and specifically, lithium cobalt oxide, lithium manganese oxide, lithium nickel oxide, lithium nickel manganese composite oxide, lithium nickel cobalt composite oxide, or the like. Al, Ti, Zr, Nb, B, W, Mg, Mo, or the like may be added to these lithium transition metal complex oxides.

As the conductive agent, carbon powders such as carbon black, acetylene black, ketjen black, graphite, and the like may be used alone or in combination of two or more.

Examples of the binder include a fluorine polymer, a rubber polymer, and the like. Examples of the fluorine polymer include polytetrafluoroethylene (PTFE), polyvinylidene fluoride (PVdF), or modified products thereof and the like, and examples of the rubber polymer include an ethylene-propylene-isoprene copolymer, an ethylene-propylene-butadiene copolymer, and the like. They may be used alone or in combination of two or more.

### <Negative Electrode>

The negative electrode comprises a negative electrode current collector such as a metal foil and a negative electrode active material layer (hereinafter, sometimes referred to as a negative electrode mixture layer) formed on the negative electrode current collector. As the negative electrode current collector, a metal foil that is stable in the potential range of the negative electrode such as copper, a film in which the metal is disposed on the surface layer, and the like can be used. In addition to the negative electrode active material, the negative electrode mixture layer preferably contains a thickener and a binder. The negative electrode can be prepared by, for example, coating a negative electrode mixture slurry in which a negative electrode active material, a thickener, and a binder are dispersed in water at a predetermined weight ratio on a negative electrode current collector, drying the coating film, and then rolling the film to form the negative electrode mixture layer on both surfaces of the negative electrode current collector.

As the negative electrode active material, a carbon material capable of occluding and releasing lithium ions can be used, and in addition to graphite, use of hardly graphitic carbon, easy graphitic carbon, fibrous carbon, coke, carbon black, and the like can be used. As a non-carbon material, silicon, tin, and alloys or oxides mainly containing them can be used.

As the binder, PTFE or the like can be used as in the case of the positive electrode, but a styrene-butadiene copolymer (SBR) or modified product thereof and the like may be used. As the thickener, carboxymethyl cellulose (CMC) or the like can be used.

### <Non-Aqueous Electrolyte>

As the non-aqueous solvent (organic solvent) of the non-aqueous electrolyte, carbonates, lactones, ethers, ketones, esters, and the like can be used, and two or more of these solvents can be used in admixture. For example, cyclic carbonates such as ethylene carbonate, propylene carbonate, and butylene carbonate; chain carbonates such as dimethyl carbonate, ethyl methyl carbonate, and diethyl carbonate; and mixed solvents of cyclic carbonates and chain carbonates can be used.

As the electrolyte salt of the non-aqueous electrolyte, LiPF₆, LiBF₄, LICF₃SO₃ and the like and these mixtures can be used. The dissolution amount of the electrolyte salt relative to the non-aqueous solvent can be, for example, 0.5 to 2.0 mol/L.

### <Separator>

As the separator, a porous sheet or the like having ion permeability and insulating properties is used. Specific examples of the porous sheet include microporous thin films, woven fabrics, nonwoven fabrics, and the like. As the material of the separator, olefinic resins such as polyethylene and polypropylene, cellulose, and the like are suitable. The separator may be a laminate having a cellulose fiber layer and a thermoplastic resin fiber layer such as an olefin resin. A multilayer separator including a polyethylene layer and a polypropylene layer may be used, and a separator coated with a material such as an aramid resin or a ceramic on the surface thereof may be used.

Examples will be described.

### EXAMPLES

### Example 1

100 parts by weight of lithium nickel cobalt aluminum composite oxide represented by LiNi_{0.88}CO_{0.09}Al_{0.03}O₂ as a positive electrode active material, 1 part by weight of acetylene black (AB), and 1 part by weight of polyvinylidene fluoride (PVdF) were mixed, and an appropriate amount of N-methyl-2-pyrrolidone (NMP) was further added thereto to prepare a positive electrode mixture slurry. The positive electrode mixture slurry was then applied to both surfaces of a positive electrode current collector of an aluminum foil and dried. This was cut into a predetermined electrode size and rolled using a roller to prepare a positive electrode in which the positive electrode mixture layer was formed on both surfaces of the positive electrode current collector. The crystal structure of LiNi_{0.88}CO_{0.09}Al_{0.03}O₂ is a layered rock salt structure (hexagonal crystal, space group R3-m). An exposed portion where the positive electrode current collector was exposed was formed without forming the positive electrode mixture layer substantially at the center portion in the longitudinal direction of the positive electrode and the positive electrode tab of aluminum was fixed to the exposed portion by ultrasonic welding.

On the other hand, a thin copper foil was used as the negative electrode current collector, and a graphite terminal, carboxymethyl cellulose (CMC) as a thickener, and styrene-butadiene rubber (SBR) as a binder at a mass ratio of 98:1:1 were dispersed in water to prepare a negative electrode mixture slurry, the slurry was applied to both surfaces of the current collector, dried, and compressed to a predetermined thickness by roll pressing. An exposed portion where the negative electrode current collector was exposed was formed without forming the negative electrode mixture layer at the end portion in the longitudinal direction of the negative electrode and the negative electrode tab of nickel was fixed to the exposed portion by ultrasonic welding.

The positive electrode tab on the exposed portion and the exposed portion were covered with an insulating tape. The negative electrode tab on the exposed portion and the exposed portion were covered with the insulating tape. The prepared positive electrode plate and negative electrode plate were spirally wound through the separator to produce a wound electrode body. As the separator, a separator having a heat resistant layer in which a filler of polyamide and alumina was dispersed formed on one surface of a polyethylene microporous film was used.

The electrode body was accommodated in a bottomed cylindrical battery case main body having an outer diameter of 18 mm and a height of 65 mm, and LiPF₆ was added so as to be 1 mol/L in a mixed solvent in which ethylene carbonate (EC), ethyl methyl carbonate (EMC) and diethyl carbonate (DEC) were mixed at a volume ratio of 3:3:4. This non-aqueous electrolyte was injected into the battery case main body, and then the opening of the battery case main body was sealed with a gasket and a sealing body to produce a cylindrical non-aqueous electrolyte secondary battery of 18650 type.

The insulating tape had a thickness of the organic material layer 50 of 25 μm, a weight composition ratio of the organic material of 100, a thickness of the composite material layer 52 of 1.0 μm, and a weight composition ratio of the composite material of inorganic material:organic material=25:75. Polyimide (PI) was used as the organic material layer 50, acrylic was used as the organic material of the composite material layer 52, and silica was used as the inorganic material.

The weight of the inorganic material was 0.80% with respect to the total weight excluding the adhesive layer.

### Example 2

The insulating tape was prepared as in Example 1, except that the thickness of the organic material layer 50 was 25 μm, the thickness of the composite material layer 52 was 5.0 μm, and the weight composition ratio of the composite material was inorganic material:organic material=35:65.

The weight of the inorganic material was 5.0% with respect to the total weight excluding the adhesive layer.

### Example 3

The insulating tape was prepared as in Example 1, except that the thickness of the organic material layer 50 was 25 μm, the thickness of the composite material layer 52 was 5.0 μm, and the weight composition ratio of the composite material was inorganic material:organic material=70:30.

The weight of the inorganic material was 10% with respect to the total weight excluding the adhesive layer.

### Example 4

The insulating tape was prepared as in Example 1, except that the thickness of the organic material layer 50 was 25 μm, the thickness of the composite material layer 52 was 1.0 μm, and the weight composition ratio of the composite material was inorganic material:organic material=35:65. The weight of the inorganic material was 1.0% with respect to the total weight excluding the adhesive layer.

### Comparative Example 1

The insulating tape was prepared as in Example 1, except that the thickness of the organic material layer 50 was 25 μm and the composite material layer 52 was not formed.

### Comparative Example 2

The insulating tape was prepared as in Example 1, except that the thickness of the organic material layer 50 was 25 μm, the thickness of the composite material layer 52 was 5.0 μm, and the weight composition ratio of the composite material was inorganic material:organic material=10:90. The weight of the inorganic material was 1.5% with respect to the total weight excluding the adhesive layer.

### Comparative Example 3

The insulating tape was prepared as in Example 1, except that the organic material layer 50 was not present, the thickness of the composite material layer 52 was 25.0 μm, and the weight composition ratio of the composite material was inorganic material:organic material=50:50. The weight of the inorganic material was 50% with respect to the total weight excluding the adhesive layer.

With respect to the non-aqueous electrolyte secondary battery obtained as described above, the piercing strength and the battery temperature at foreign matter short circuit were measured. The piercing strength was measured by piercing the surface of the insulating tape with a needle and measuring the pressing force (N) by appearance observation in penetration.

The battery temperature at foreign matter short circuit was measured by placing a foreign matter (nickel piece) on the insulating tape and measuring the temperature at the side of the battery with a thermocouple at forced short circuit according to JIS C 8714. In this case, however, a severe test was conducted using a nickel piece having a larger size instead of a standard test using a nickel piece having a standard size. The nickel piece was placed between the insulating tape and the separator so that the piece penetrated the insulating tape. At this time, the highest attainable temperature of the battery side surface was measured with a thermocouple. The result is shown in Table 1.

### (Nickel Piece Used in Standard Test)

L shape (angle 90°) with a height of 0.2 mm, a width of 0.1 mm, and a side of 1 mm

### (Nickel Piece Used in Severe Test)

L shape (angle 90°) with a height of 0.2 mm, a width of 0.1 mm, and a side of 2 mm

TABLE 1

| | Organic layer | | Composite layer | | | | Battery |
|---|---|---|---|---|---|---|---|
| | | Weight composition | | Weight composition | | | temperature |
| | | ratio | | ratio | Inorganic material/ | Piercing | at foreign matter |
| | Thickness | Inorganic material/Organic | Thickness | Inorganic material/Organic | (Organic layer weight + | strength | short circuit |
| | [μm] | material | [μm] | material | Composite layer weight) | [N] | [° C.] |
| Example 1 | 25.0 | 0/100 | 1.0 | 25/75 | 0.80% | 11.0 | 86 |
| Example 2 | 25.0 | 0/100 | 5.0 | 35/65 | 5.0% | 11.3 | 48 |
| Example 3 | 25.0 | 0/100 | 5.0 | 70/30 | 10% | 11.0 | 35 |
| Example 4 | 25.0 | 0/100 | 1.0 | 35/65 | 1.0% | 11.1 | 55 |
| Comparative | 25.0 | 0/100 | None | None | 0.0% | 108. | >100 |
| Example 1 | | | | | | | |
| Comparative | 25.0 | 0/100 | 5.0 | 10/90 | 1.5% | 11.6 | >100 |
| Example 2 | | | | | | | |
| Comparative | None | None | 25.0 | 50/50 | 50% | 7.3 | 74 |
| Example 3 | | | | | | | |

In Example 1, the thickness of the organic material layer 50 was 25.0 μm, the weight composition ratio of the organic material was 100, the thickness of the composite material layer 52 was 1.0 μm, the weight composition ratio of the composite material was inorganic material:organic material=25:75, the piercing strength was 11.0 N, and the battery temperature at foreign matter short circuit was 86° C.

In Example 2, the thickness of the organic material layer 50 was 25.0 μm, the thickness of the composite material layer 52 was 5.0 μm, the weight composition ratio of the composite material was inorganic material:organic material=35:65, the piercing strength was 11.3 N, and the battery temperature at foreign matter short circuit was 48° C. In Example 2, the heat resistance was improved probably due to larger thickness of the composite material layer 52 than that in Example 1. In Examples 2 and 1, the piercing strength hardly changed due to the same organic material layer 50.

In Example 3, the thickness of the organic material layer 50 was 25.0 μm, the thickness of the composite material layer 52 was 5.0 μm, the weight composition ratio of the composite material was inorganic material:organic material=70:30, the piercing strength was 11.0 N, and the battery temperature at foreign matter short circuit was 35° C. In Example 3, the heat resistance was further improved probably due to larger weight composition ratio of the inorganic material than that in Example 2. In Examples 3 and 2, the piercing strength hardly changed due to the same organic material layer 50.

In Example 4, the thickness of the organic material layer 50 was 25.0 μm, the thickness of the composite material layer 52 was 1.0 μm, the weight composition ratio of the composite material was inorganic material:organic material=35:65, the piercing strength was 11.1 N, and the battery temperature at foreign matter short circuit was 55° C. In Example 4, the heat resistance was further improved probably due to a larger weight composition ratio of the inorganic material than that in Example 1.

In Comparative Example 1, the thickness of the organic material layer 50 was 25.0 μm, the composite material layer 52 was not formed, the piercing strength was 10.8 N, and the battery temperature at foreign matter short circuit was more than 100° C. In Comparative Example 1, the heat resistance was found not to be ensured, since the composite material layer 52 was not present and the organic material layer 50 and the adhesive layer 54 was only present.

In Comparative Example 2, the thickness of the organic material layer 50 was 25.0 μm, the thickness of the composite material layer 52 was 5.0 μm, the weight composition ratio of the composite material was inorganic material:organic material=10:90, the piercing strength was 11.6 N, and the battery temperature at foreign matter short circuit was more than 100° C. In Comparative Example 2, the heat resistance was reduced probably due to a smaller weight composition ratio of the inorganic material than that in Example 1.

In Comparative Example 3, the organic material layer 50 was not present, the thickness of the composite material layer 52 was 25.0 μm, the weight composition ratio of the composite material was inorganic material:organic material=50:50, the piercing strength was 7.3 N, and the battery temperature at foreign matter short circuit was 74° C. In Comparative Example 3, the piercing strength was reduced probably due to no organic material layer 50 unlike Example 1. In Comparative Example 3, the heat resistance was improved probably due to a larger weight composition ratio of the inorganic material in the composite material layer 52 than that in Comparative Examples 1 and 2.

As a result, the insulating tape is composed of the three-layer structure of the organic material layer 50/the composite material layer 52/the adhesive layer 54 (substantially the two-layer structure of the organic material layer 50/the composite material layer 52), allowing heat resistance and piercing strength (mechanical strength) to be satisfied at the same time. From the view point of ensuring heat resistance, the weight composition ratio of the inorganic material in the composite material layer 52 is 20% or more, preferably 35 to 80%, and the thickness of the composite material layer 52 is preferably 1 to 5 μm.

The non-aqueous electrolyte secondary battery of the present embodiment can be applied to a drive power source of a mobile information terminal such as a mobile phone, a notebook computer, a smartphone, a tablet terminal, particularly, an application requiring a high energy density. In addition, applications such as electric vehicles (EV), hybrid electric vehicles (HEV or PHEV), and power tools are also possible.

### INDUSTRIAL APPLICABILITY

The present invention can be applied to a non-aqueous electrolyte secondary battery.

### REFERENCE SIGNS LIST

1 Insulating tape
50 Organic material layer
52 Composite material layer
54 Adhesive layer
60 Electrode
62 Current collector
62a Exposed portion
64 Active material layer
66 Electrode tab
68 Boundary portion

1. A non-aqueous electrolyte secondary battery, comprising:
a positive electrode; and
a negative electrode,
wherein at least any one of the positive and negative electrodes comprising:
a current collector;
an active material layer formed on the current collector;
an electrode tab joined to an exposed portion where the active material layer is not formed and the current collector is exposed; and
an insulating tape covering the electrode tab on the exposed portion,
wherein the insulating tape has a multilayer structure including an organic material layer mainly composed of an organic material and a composite material layer containing an organic material and an inorganic material;
the inorganic material in the composite material layer accounts for 20% or more of the weight of the composite material layer; and
the inorganic material includes at least one selected from the group consisting of a metal oxide, a metal nitride, a metal fluoride, and a metal carbide.

2. The non-aqueous electrolyte secondary battery according to claim 1, wherein the insulating tape covers at least a part of the exposed portion.

3. A non-aqueous electrolyte secondary battery, comprising:
a positive electrode; and
a negative electrode,
wherein at least any one of the positive and negative electrodes comprising:
a current collector;
an active material layer formed on the current collector; and
an insulating tape covering a boundary portion between an exposed portion where the active material layer is not formed and the current collector is exposed and the active material layer,
wherein the insulating tape has a multilayer structure including an organic material layer mainly composed of an organic material and a composite material layer containing an organic material and an inorganic material;
the inorganic material in the composite material layer accounts for 20% or more of the weight of the composite material layer; and
the inorganic material includes at least one selected from the group consisting of a metal oxide, a metal nitride, a metal fluoride, and a metal carbide.

4. The non-aqueous electrolyte secondary battery according to claim 1, wherein the inorganic material in the composite material layer accounts for 35% or more and 80% or less of the weight of the composite material layer.

5. The non-aqueous electrolyte secondary battery according to claim 1, wherein the composite material layer has a thickness of 1 μm or more and 5 μm or less.

6. The non-aqueous electrolyte secondary battery according to claim 1, wherein the inorganic material includes at least any one of aluminum oxide, titanium oxide, magnesium oxide, zirconium oxide, nickel oxide, silicon oxide, manganese oxide, titanium nitride, boron nitride, aluminum nitride, magnesium nitride, silicon nitride, aluminum fluoride, lithium fluoride, sodium fluoride, magnesium fluoride, calcium fluoride, barium fluoride, silicon carbide, boron carbide, titanium carbide, and tungsten carbide.

7. The non-aqueous electrolyte secondary battery according to claim 1, wherein the organic material contained in the composite material layer includes at least any one of a rubber resin, an acrylic resin, an epoxy resin, or a silicone resin.

8. The non-aqueous electrolyte secondary battery according to claim 1, comprising
an adhesive layer formed on the composite material layer,
wherein the organic material in the composite material layer and the adhesive layer are composed of a same type resin.

9. The non-aqueous electrolyte secondary battery according to claim 8, wherein the same type resin includes at least any one of a rubber resin, an acrylic resin, an epoxy resin, or a silicone resin.

10. The non-aqueous electrolyte secondary battery according to claim 1, wherein a weight of the inorganic material is less than 20% with respect to the total weight of the organic material layer and the composite material layer.

11. The non-aqueous electrolyte secondary battery according to claim 1, wherein the organic material contained in the organic material layer includes at least any one of PPS (polyphenylene sulfide), PEEK (polyether ether ketone), PI (polyimide), PP (polypropylene), PET (polyethylene terephthalate), and PBT (polybutylene terephthalate).

12. The non-aqueous electrolyte secondary battery according to claim 3, wherein the inorganic material in the composite material layer accounts for 35% or more and 80% or less of the weight of the composite material layer.

13. The non-aqueous electrolyte secondary battery according to claim 3, wherein the composite material layer has a thickness of 1 μm or more and 5 μm or less.

14. The non-aqueous electrolyte secondary battery according to claim 3, wherein the inorganic material includes at least any one of aluminum oxide, titanium oxide, magnesium oxide, zirconium oxide, nickel oxide, silicon oxide, manganese oxide, titanium nitride, boron nitride, aluminum nitride, magnesium nitride, silicon nitride, aluminum fluoride, lithium fluoride, sodium fluoride, magnesium fluoride, calcium fluoride, barium fluoride, silicon carbide, boron carbide, titanium carbide, and tungsten carbide.

15. The non-aqueous electrolyte secondary battery according to claim 3, wherein the organic material contained in the composite material layer includes at least any one of a rubber resin, an acrylic resin, an epoxy resin, or a silicone resin.

16. The non-aqueous electrolyte secondary battery according to claim 3, comprising
an adhesive layer formed on the composite material layer,
wherein the organic material in the composite material layer and the adhesive layer are composed of a same type resin.

17. The non-aqueous electrolyte secondary battery according to claim 16, wherein the same type resin includes at least any one of a rubber resin, an acrylic resin, an epoxy resin, or a silicone resin.

18. The non-aqueous electrolyte secondary battery according to claim 3, wherein a weight of the inorganic material is less than 20% with respect to the total weight of the organic material layer and the composite material layer.

19. The non-aqueous electrolyte secondary battery according to claim 3, wherein the organic material contained in the organic material layer includes at least any one of PPS (polyphenylene sulfide), PEEK (polyether ether ketone), PI (polyimide), PP (polypropylene), PET (polyethylene terephthalate), and PBT (polybutylene terephthalate).
